(19) United States
(12) Patent Application Publication
(10) Pub. No.: US 2005/0226466 A1
(43) Pub. Date: Oct. 13, 2005

(54) Image acquisition assembly

(75) Inventor: John C. Seymour, Genesee Depot, WI (US)

Correspondence Address: MICHAEL BEST & FRIEDRICH, LLP, 100 E WISCONSIN AVENUE, MILWAUKEE, WI, 53202, US

(73) Assignee: Quad/Tech, Inc., Sussex, WI (US)

(21) Appl. No.: 10/818,835

(22) Filed: Apr. 6, 2004

(51) Int. Cl. G01V 8/00; G01N 21/89

(52) U.S. Cl. 382/112; 250/559.01

(57) ABSTRACT

An assembly and method for image data acquisition is provided for obtaining image data representative of a printed work on a moving web in a printing press. The assembly includes a light source for illuminating the web, an optical fiber taper for minifying an image from a first end to a second end of the taper, wherein the first end of the taper is in optical communication with the printed work on the web, a sensor coupled to the second end of the taper, and a processor for receiving image data representative of the printed work from the sensor.

### FIELD OF THE INVENTION

The present invention relates generally to an image acquisition assembly for a printing press, and more particularly, to an image acquisition assembly including a sensor and an associated optical fiber element for obtaining image data from a moving web.

### BACKGROUND OF THE INVENTION

Ink color control systems, color registration systems, and defect detection systems are known systems used in connection with monitoring the quality of a printed work on a web in a printing press. Such systems often use a camera or line scan sensor to obtain image data from a portion of the moving web. Typically, the acquired image data is compared to reference image data. The resultant information is used, for example, to control the amount of ink applied to the web, the alignment of the printing plates with respect to each other, or to mark or track the whereabouts of resultant defective printed product.

More specifically, in a typical ink color control system for controlling the amount of ink applied on a printing press, a camera moves across the web to collect image data representative of color patches printed on the web. Pixels of the color patch image data are then processed, and assigned a color value that is compared against a desired color value. If the absolute difference between the desired color value and the determined color value for a number of pixels in an ink key zone is outside a predetermined tolerance, an associated ink key is then controllably adjusted to effect a change in the ink flow rate. Markless color control systems are also known that do not require the use of separate color patches but instead measure color values in the desired graphical/textual printed work itself. Examples of ink color control systems are described in U.S. Pat. Nos. 5,967,049 and 6,318,260.

A typical defect detection system also acquires an image of the printed web. The acquired image is subsequently compared to a stored digital template image. Any discrepancy between the acquired image and the template image beyond some tolerance is considered to be a defect. The defects are then logged in a data file, and can be categorized as isolated defects or non-isolated defects. Non-isolated defects occur when the system detects a change in color due to a change in inking level over a large portion of the web. When non-isolated defects are reported, an alarm will subsequently be set off to alert an operator to take appropriate corrective action. Isolated defects can be tracked such that the associated printed products are marked as defective, or are otherwise separated from the acceptable printed products.

Color registration systems typically also compare acquired image data to reference image data in order to adjust the registration or alignment of each ink color with respect to the others by adjusting the alignment of the printing plates with respect to each other. Color registration systems using marks or patches are known, as are markless systems. Examples of such systems are described in U.S. Pat. Nos. 5,412,577 and 5,689,425.

These control systems all require image data to be acquired from the printed work on the web, and vary in the amount and resolution of data required. For example, to detect defects in the entire printed work, it is advantageous for a defect detection system to acquire image data across the entire width of the web. Similarly, an ink key control system, because it controls ink keys across the lateral extent of the web, would preferably obtain image data from patches (or the desired printed work itself) across the entire width of the web. However, a color registration system using color patches may need to provide image data only of the patches (or a portion of the desired printed work) that would not necessarily extend across the entire web width. When obtaining image data representing the image across the entire lateral extent of the web, to minimize costs, it is desirable to use as few sensors as possible.

It is known to use area array sensors, i.e., sensors with two-dimensional arrays of pixels, such as a video camera, to obtain a two dimensional image of the web at a specific point in time. It is also known to use line scan sensors, having a single line of pixels, aligned across the web to essentially obtain a one-dimensional image data slice. In this case, the “vertical” resolution of the line scanner is obtained from the motion of the web.

### SUMMARY OF THE INVENTION

The invention provides an image data acquisition assembly for obtaining image data representative of a printed work on a moving web in a printing press. The assembly includes a light source for illuminating the web, and an optical fiber taper that is in optical communication with the printed work on the web for minifying an image from a first end to a second end of the taper. The assembly also includes a sensor coupled to the second end of taper, and a processor for receiving image data representative of the printed work from the sensor.

The invention further defines a method for acquiring image data representative of a portion of a printed work on a moving web. The method includes the steps of using an optical fiber taper comprising a bundle of fibers to minify an image of a printed work on the web from one end of the taper to a second end of the taper. The second end of the optical fiber taper is connected to a plurality of pixels of a line scan sensor. The image data is shifted out of the line scan sensor to a processor.

Both area array sensors and line scan sensors typically have a pixel size that is smaller than the smallest dimension that is required to be discerned in typical applications. Thus, it is desirable to match the image resolution obtained in a specific application to the available resolution of the sensor.

Other features and advantages of the invention will become apparent by consideration of the detailed description and accompanying drawings.

### BRIEF DESCRIPTION OF THE DRAWINGS

FIG. 1 is a perspective view of a portion of a printing press;

FIG. 2 is a side view of one embodiment of a scanner assembly;

FIG. 3 is a perspective view of an image sensor such as a line scan sensor;

FIG. 4 is a perspective view of the web, an optical fiber element and sensor; and

FIG. 5 is a front view of an optical fiber taper and sensor.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### DETAILED DESCRIPTION OF THE PREFERRED EMBODIMENTS

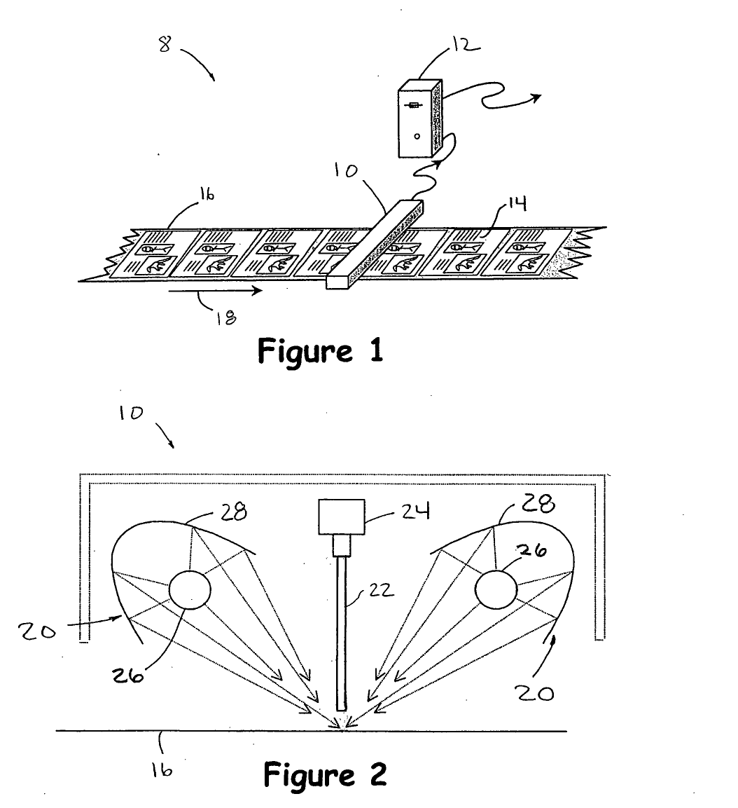

FIG. 1 illustrates an image data acquisition assembly 8 including a scanner assembly 10 and a system processor 12 for acquiring image data from a web 16 in a printing press. The scanner assembly 10 collects image data from a printed work 14 on a web 16 that is moving in a direction 18, termed the longitudinal direction. The image data may represent color information in the printed work 14. Once collected, the acquired image data is transferred to the processor 12 for processing. The processing can include, for example, comparison with reference image data for ink color control, color registration, and/or defect detection purposes, or for other applications.

One embodiment of the scanner assembly 10 is illustrated in FIG. 2. Scanner assembly includes light source 20 for illuminating the printed work on the web. Scanner assembly further includes an optical fiber element 22 and an image sensor 24 that senses reflected light from the web via the optical fiber element.

In one embodiment, the light source 20 includes a pair of fluorescent bulbs 26, with one bulb located upstream and one downstream from the image sensor 24. Each bulb has an associated reflector 28 and is arranged above the web in a lateral direction across the web that is substantially perpendicular to the longitudinal direction 18. As the web 16 moves, an encoder signal from the printing press drives a shutter mechanism to trigger acquisitions of data, as is known in the art. At each acquisition, the image sensor 24 senses a portion of the efflux light that is reflected from the web 16 via the optical fiber element 22.

When the web 16 is travelling at a high-speed or the printed work is printed at a fine resolution, the light source 20 is typically powered by a high frequency power supply to maintain a relatively constant strength of illumination from one image line to the next. In another embodiment (not shown), the light source can be a tube-shaped halogen bulb with a filament running parallel to the web. The tube-shaped halogen bulb typically provides illumination stability until its point of failure, and the filament provides substantially uniform illumination across the web. Other light sources can be used, including for example a series of conventional incandescent bulbs.

In one embodiment, the reflector 28 may have a general shape that is a portion of an ellipse having two foci, wherein the light source 20 is substantially aligned at the first focus and the second focus is generally at a point below the image sensor 24 and on or just above the web 16. As illustrated, the two reflectors 28 can be aligned such that the second focus of each reflector is substantially coincident.

The image sensor 24 can be, for example, an area array sensor or a line scan sensor and may include sensing elements such as charge-coupled devices (CCDs) or complementary metal-oxide semiconductor (CMOS) devices, or the like. Such sensors are available in the form of a semiconductor chip. The image sensor may include a plurality of independent image channels responsive to different wavelength ranges.

Using area array sensors to image the high-speed motion of continuous webs requires short exposure times and strobed illumination in order to “stop the action”. In general, this adds to the complexity and expense of obtaining image data from a moving web when compared to using a line scan sensor. Additionally, even illumination of the web for an area array sensor is generally more complex compared to the use of a line scan sensor. Further, the readout of the image data from a line scan sensor is generally simpler and quicker.

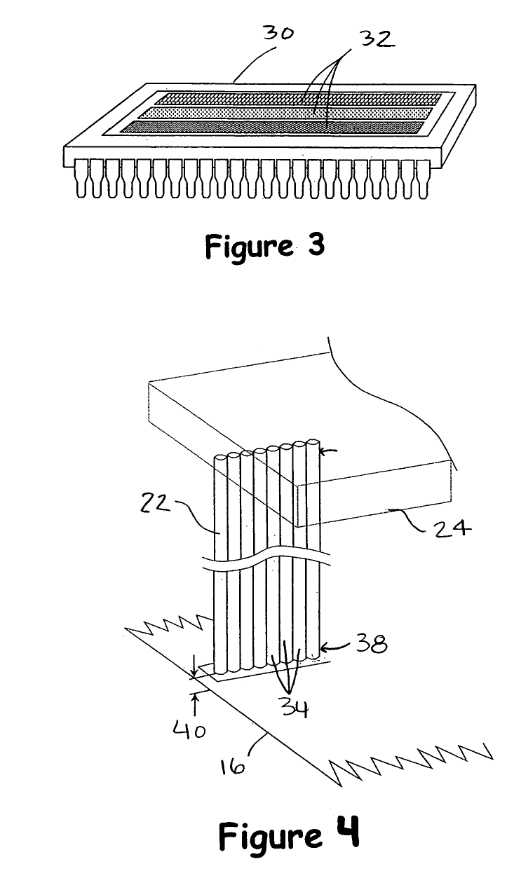

In one embodiment, as shown in FIG. 3, a trilinear line scan image sensor 30, such as the Eastman Kodak KLI-6603, can be used. Such a sensor is a compact integrated circuit and includes three substantially parallel sensing regions 32 laid out along the length of the sensor. Each region further includes a spectral filter that provides for the selective passage of light into the sensing elements, according to the wavelength of incoming light.

In another embodiment (not shown), the image sensor includes three channels responsive generally to the wavelength ranges 400 to 500 nanometers, 500 to 600 nanometers, and 600 to 700 nanometers. These three channels are referred to as the blue, green and red channels, respectively. If the densitometric fidelity is more important than the calorimetric fidelity in the print work, the spectral responsivity of the three channels will be designed to comply with the definitions of Status T or Status E as defined in ISO 5-3, or with the German standard DIN 16536, for example. If the colorimetric fidelity is more important than the densitometric fidelity, the three channels would be designed to meet the Luther-Ives condition. Spectral responsivities that meet the Luther-Ives condition are 1) spectral responsivities that are each a linear combination of the tristimulus functions, as defined in ISO 15-2, and 2) spectral responsivities that span the three-space of the tristimulus functions.

To provide flexibility in the placement of the image sensor 24 and allow the image sensor 24 to be physically separated from the web 16, the optical fiber element 22 is located between the printed work 14 on the web 16 and the sensor 24 and couples an image from its input end to its output end. For example, as shown in FIG. 4, the optical fiber element 22 can be an optical fiber array having a plurality of optical fibers 34 each coupled to one of the pixels of the sensor 24. The optical fiber array, acting as a lens with a 1:1 magnification ratio, transfers reflected light from the printed work 14 on the web 16 to the image sensor 24 and is arranged substantially perpendicular to the body of the image sensor 24. Each individual optical fiber 34 preferably has a core diameter that is approximately the size of one of the sensor pixels, or smaller, and has a sensor end 36 and a web end 38. The sensor end 36 is aligned such that each fiber 34 of the array is essentially in direct contact with the sensor 24. When the diameters of the cores of the optical fibers of the array are significantly smaller than the sensor pixels, and when the array includes a plurality of rows of optical fiber strands, the deleterious effects of imperfect alignment on image quality are generally minimized.

The distance between the web 16 and the web end 38 of the optical fiber element 22, generally referred to as a working distance 40, is preferably small. In this manner, the angular rejection inherent to the optical fiber array reduces the contamination of light from one sensor pixel to the next, and the use of the reflected light is maximized. For image pixels of desired size 339 μm, which corresponds to a printing resolution of 75 dots per inch (DPI), and a numerical aperture of 0.025 for the optical fibers of the array, a working distance 40 of no less than approximately ¼ inch is preferred. A spectral filter, if not a part of the sensor, can also be affixed to the web ends for each color channel.

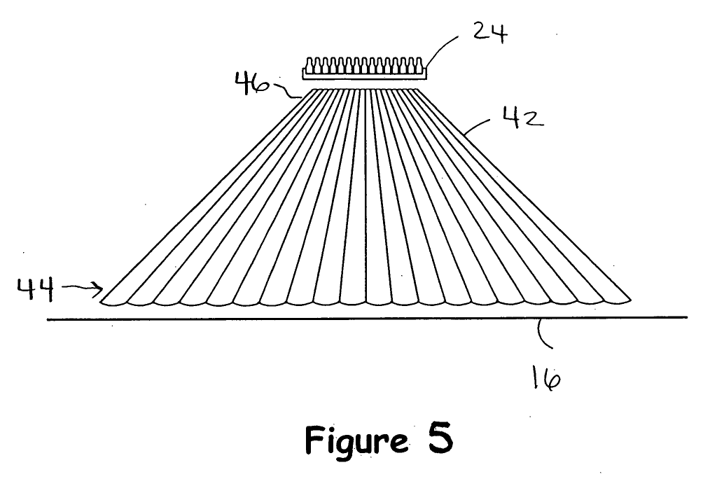

The optical fiber element 22 can also be an optical fiber taper 42 as shown in the embodiment illustrated in FIG. 5. Such an optical fiber taper 42 can be a coherent fiber optical plate that includes a bundle of fibers and transmits a reduced image from its input surface at an end 44 to its output surface at a second end 46. The optical fiber taper 42 can be used to match the image resolution of the printed work on the web (i.e., the minimum feature size) to the pixel size of the image sensor. Further, an optical fiber taper with minification allows a larger scan area to be imaged by the sensor. For applications that require image data to be obtained from a scan area greater than the size of the sensor, the optical fiber taper allows for fewer sensors to be used.

In one embodiment, the optical fiber taper 42 includes a bundle of fibers matching the number of pixels the image sensor includes, and has a small end diameter that is optimized for 1/2 inch or 2/3 inch CCD chip sizes.

The selection of an appropriate sensor 24 requires several considerations. These include a pixel size matching issue as well as a sensor speed issue.

CCD or CMOS sensors typically have pixel sizes that are smaller than the resolution required for a particular imaging application. Although larger pixel sizes for the sensors are also available, these sensors are inherently slower than those with small pixels due to the physical limitations involved. For example, a typical CCD sensor pixel size is around 10 μm to 20 μm, and a typical CMOS sensor pixel size is 40 μm to 80 μm, while a desired resolution for imaging may be in the range of 300 μm pixels. An optical fiber taper can operate to minify an image by a predetermined factor, which is the ratio of the diameter of the first end to the second end of the taper, to thereby match desired image resolution to the image sensor pixel size.

For example, using a line scan sensor having a pixel size of 14 μm and a printing resolution of 300 μm results in a desired lateral minification factor of around 22. A typical minification ratio for available optical fiber tapers is around 5. This means that further minification may be necessary.

An electrical minification process known as binning can also perform a reduction of resolution in the lateral direction (i.e., across the web). A line scan sensor has a readout stage that is effectively a capacitor. Under normal operation, the analog charge of each of the sensor pixels are sequentially shifted into the capacitor, the charge is sampled, and the capacitor is then reset before the next pixel charge is shifted in. In binning, multiple pixels are shifted into the capacitor before each readout and reset. As a result, a sensor with a particular pixel size is able to emulate a second sensor with a lateral pixel size that is an integer multiple larger than the original lateral pixel size. For a desired image resolution of approximately 300 μm, binning 22 pixels (having a size of 14 μm) together will produce a lateral pixel size of 308 μm.

In other words, image minification in the lateral dimension can be achieved through a combination of sensor selection, optical fiber taper size selection, and binning.

The sensor speed issue referred to above relates to the fact that it is generally desirable to have the vertical resolution the same as the horizontal resolution of the sensor pixel. For example, for a web that moves through a printing press at a high speed, it is important to provide an appropriate sensor in terms of number of pixels and maximum clock speed.

For example, the IL-P3-1024 CCD line scan sensor from Dalsa, Inc. of Waterloo, Ontario, Canada has 1,024 pixels that are 14 μm by 14 μm, and a maximum clock rate of 40 MHz. With such a sensor, the pixels can be clocked out at a maximum speed of approximately 39,000 lines/second. A typical web speed is 3000 feet per minute (600 inches per second). If the desired image pixel resolution is around 300 μm in the longitudinal direction, the image should be sampled at a rate of roughly 50,800 times per second, or about every 22 μsec, to achieve the required image resolution in terms of pixel height. However, the maximum line rate is only 37,000 lines per second. An alternative CCD device is the IL-P3-0512 sensor from Dalsa. This sensor has the same 14 μm by 14 μm pixel size and the same maximum clock rate, but has 512 pixels and hence, is capable of acquiring 78,000 lines per second.

Consequently, resolution adjustment in the longitudinal direction is possible by appropriate sensor selection and clock speed, taking into account the speed of the web.

Various features and advantages of the invention are set forth in the following claims.

1. An image data acquistion assembly for obtaining image data representative of a printed work on a moving web in a printing press, comprising:
a light source for illuminating the web,
an optical fiber taper for minifying an image from a first end to a second end of the taper, wherein the first end of the taper is in optical communication with the printed work on the web,
a sensor coupled to the second end of the taper and having a plurality of pixels, and
a processor for receiving image data representative of the printed work from the sensor.

2. The image data acquisition assembly of claim 1, wherein the sensor is a line scan sensor.

3. The image data acquisition assembly of claim 1, wherein the sensor is an area array sensor.

4. The image data acquisition assembly of claim 1, wherein the sensor is a CCD sensor.

5. The image data acquisition assembly of claim 1, wherein the sensor is a CMOS sensor.

6. The image data acquisition assembly of claim 1, wherein the optical fiber taper comprises a bundle of fibers and each fiber is individually connected to one of the pixels of the sensor.

7. The image data acquisition assembly of claim 6, wherein the image data received by the processor has been binned in the sensor from a plurality of pixels.

8. An image data acquisition assembly for obtaining image data representative of a printed work on a web moving in a first direction, comprising:
a line scan sensor arranged in a second direction that is transverse to the first direction and having a plurality of pixels each having a pixel width along the second direction,
an optical fiber element having a first side in optical communication with the printed work on the web and a second side coupled to the line scan sensor, the optical element coupling an image at a respective area of the printed work to one of the plurality of pixels, wherein the width of each respective area is greater than the pixel width, and
a processor for receiving image data from the line scan sensor.

9. The assembly of claim 8, wherein the optical fiber element includes a plurality of optical fibers.

10. The assembly of claim 9, wherein the optical fibers are tapered.

11. The assembly of claim 9, wherein the optical fibers are coherent.

12. The assembly of claim 9, wherein the optical fibers minify an image of the printed work from the first side to the second side.

13. A method for acquiring image data representative of a portion of a printed work on a moving web, comprising the steps of:
using an optical fiber taper comprising a bundle of fibers to minify an image of a printed work on the web from one end of the taper to a second end of the taper,
connecting the second end of the optical fiber taper to a plurality of pixels of a line scan sensor, and
shifting the image data out of the line scan sensor to a processor.
